(19) United States
(12) Patent Application Publication
(10) Pub. No.: US 2025/0166135 A1
(43) Pub. Date: May 22, 2025

(54) FINE-GRAINED CONTROLLABLE VIDEO GENERATION

(71) Applicant: Google LLC, Mountain View, CA (US)

(72) Inventors: Yu-Chuan Su, Bellevue, WA (US); Hsin-Ping Huang, Mountain View, CA (US); Ming-Hsuan Yang, Sunnyvale, CA (US); Deqing Sun, Boston, MA (US); Lu Jiang, Mountain View, CA (US); Yukun Zhu, Shoreline, WA (US); Xuhui Jia, Bellevue, WA (US)

(21) Appl. No.: 18/951,203

(22) Filed: Nov. 18, 2024

Related U.S. Application Data
(60) Provisional application No. 63/600,633, filed on Nov. 17, 2023.

(51) Int. Cl. G06T 5/60; G06T 7/00; G06T 7/246; G06T 11/20; G06T 11/60

(52) U.S. Cl. CPC G06T 5/60; G06T 7/0002; G06T 7/248; G06T 11/203; G06T 11/60; G06T 2200/24; G06T 2207/10016; G06T 2207/20081; G06T 2207/20084; G06T 2207/20101; G06T 2207/30168; G06T 2207/30241

(57) ABSTRACT

Methods, systems, and apparatus, including computer programs encoded on computer storage media, for controllable video generation. One of the methods includes receiving a text prompt that specifies an object; receiving a control input that comprises an image that depicts a particular instance of the object; generating a video that comprises a respective video frame at each of a plurality of time steps in the video and that depicts the particular instance of the object. Generating the video includes, at each of the plurality of time steps: obtaining a text prompt embedding; obtaining a control input embedding; and generating the respective video frame at the time step using a video generation neural network while the video generation neural network is conditioned on the text prompt embedding and on the control input embedding.

### CROSS-REFERENCE TO RELATED APPLICATIONS

This application claims priority to U.S. Provisional Application No. 63/600,633, filed on Nov. 17, 2023. The disclosure of the prior application is considered part of and are incorporated by reference in the disclosure of this application.

### BACKGROUND

This specification relates to processing videos using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a controllable video generation system implemented as computer programs on one or more computers in one or more locations that generates a video conditioned on a text prompt and a control input. The video includes a respective video frame at each of a plurality of time steps. Each video frame can be an image that can be represented as a two-dimensional (2D) array of pixels, where each pixel is represented as a vector of one or more values.

The control input provides additional information that supplements the information contained in the text prompt in order for the system to achieve controllable video generation. In some cases, the control input includes one or more images. In some other cases, the control input includes location data that defines a location of one or more objects to be depicted in the video. In yet other cases, the control input includes both one or more images and location data.

The subject matter described in this specification can be implemented in particular embodiments so as to realize one or more of the following advantages.

The specification describes a controllable video generation system that can generate long, multi-scene videos from text prompts and additional control inputs while maintaining temporal coherence and relevance to both the text prompt and the additional control inputs. Unlike in some known text-to-video generation systems where videos are generated from just text descriptions, the controllable video generation system can generate videos by additionally conditioning the video generation process on control inputs that include data other than text, e.g., an image or a sketch, that may be provided by a user.

The controllable video generation system thus provides users with greater controllability over the content of the generated videos. For example, the system can generate videos that accurately show an object that has a particular appearance as defined by the user, a particular movement as defined by the user, or both.

The specification also describes techniques to realize this improvement without a significant increase in computational resource usage. Advantageously, the described techniques can quickly configure a pre-trained text-to-video model to generate videos conditioned on the additional control inputs by inserting new adaptive cross-attention layers into the pre-trained text-to-video model and subsequently training the text-to-video model to update the parameter values of the newly inserted adaptive cross-attention layers while holding the pre-trained parameter values of the existing layers of the model fixed. Thus, a significant increase in resource usage can be avoided because training a new model from scratch or fine-tuning a pre-trained model to update the values of a greater number of model parameters in order to cause the model to effectively condition on the control input is not required.

Generating a video is computationally expensive. Existing techniques, e.g., those that only accept text prompt as inputs, often require generating a large number of candidate videos to arrive at a final video that has the desired content. In contrast, the controllable video generation system described in this specification can avoid this by allowing the user to provide a control input, thereby decreasing computational resources use, e.g., processing power and memory consumption.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example controllable video generation system.

FIG. 2 is an example illustration of operations performed by a controllable video generation system to generate a video.

FIG. 3A illustrates example architectures of a joint encoder neural network and a video generation neural network.

FIG. 3B illustrates example operations performed by a joint encoder neural network at each time step.

FIG. 3C illustrates example operations performed by a controllable video generation system.

FIG. 4 shows an example training system.

FIG. 5 is a flow diagram of an example process for training a joint encoder neural network and a video generation neural network.

FIG. 6 is a flow diagram of an example process for generating a video.

Like reference numbers and designations in the various drawings indicate like elements.

### DETAILED DESCRIPTION

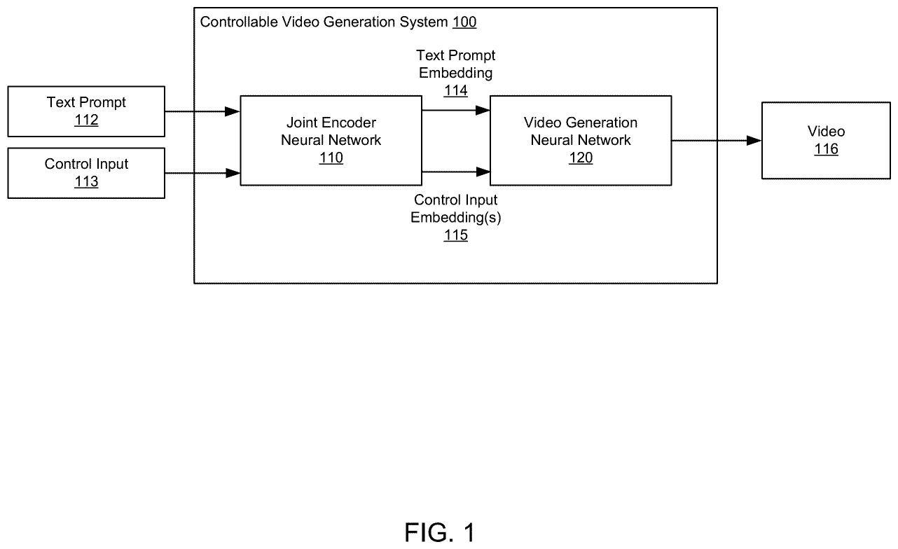

FIG. 1 shows an example controllable video generation system 100. The controllable video generation system 100 is an example of a system implemented as computer programs on one or more computers that generates a video 116 conditioned on a text prompt 112 and a control input 113. The video 116 includes a respective video frame at each of a plurality of time steps. Each video frame can be an image that can be represented as a two-dimensional (2D) array of pixels, where each pixel is represented as a vector of one or more values.

The controllable video generation system 100 can receive the text prompt 112, e.g., from a user of the system. For example, the text prompt 112 can include any sequence of text in a natural language that specifies one or more objects (or entities) that should appear in the video to be generated by the system. The user can submit the text prompt in any of a variety of ways, e.g., by entering text using an input device or by submitting an audio input that is transcribed by the system.

Examples of objects that can be specified in the text prompt 112 include landmarks, landscape or location features, vehicles, tools, food, clothing, devices, animals, human, to name just a few.

In addition, the controllable video generation system 100 can also receive the control input 113, e.g., from the same user who also provided the text prompt 112 or another user, or from a storage device of the system or another system. Generally, the control input 113 provides additional information that supplements the information contained in the text prompt 112 in order for the system to achieve controllable video generation.

In some cases, the control input 113 includes one or more images, and the system can obtain the images, e.g., as an upload by a user of the system or from a storage device of the system or another system. For example, the control input 113 can include an image for each of one or more objects to be depicted in the video, e.g., for each of the one or more objects specified in the text prompt 112. For each object, the image can provide information about the appearance, e.g., color, texture, or another visual attribute, of the object specified in the text prompt 112.

In some other cases, the control input 113 includes location data that defines a location of one or more objects to be depicted in the video, e.g., of each object specified in the text prompt 112 within the respective video frame at each of the plurality of time steps. Specifically, at each time step, the location data can include coordinate locations (e.g., X-Y coordinates) of a reference point of an object in a video frame. The reference point can be a point can be centered on the object, positioned at a corner of a bounding box that encompasses the object, or other suitable location.

For example, the control input 113 can include another text input, e.g., another text prompt. The other text prompt can likewise include any sequence of text in a natural language that specifies the location of each of the one or more objects. For example, the other text prompt can define the locations of each object either directly, e.g., by defining the values of the coordinates of the object, or indirectly, e.g. by characterizing a trajectory of the object, e.g., “the motorcyclist moves from right to left” or “the cat heads upward starting from the bottom.”

As another example, the control input 113 can include one or more user inputs that define or otherwise specify a trajectory of the object. The trajectory contains information from which the locations of each object within the video frames across the plurality of time steps can be derived.

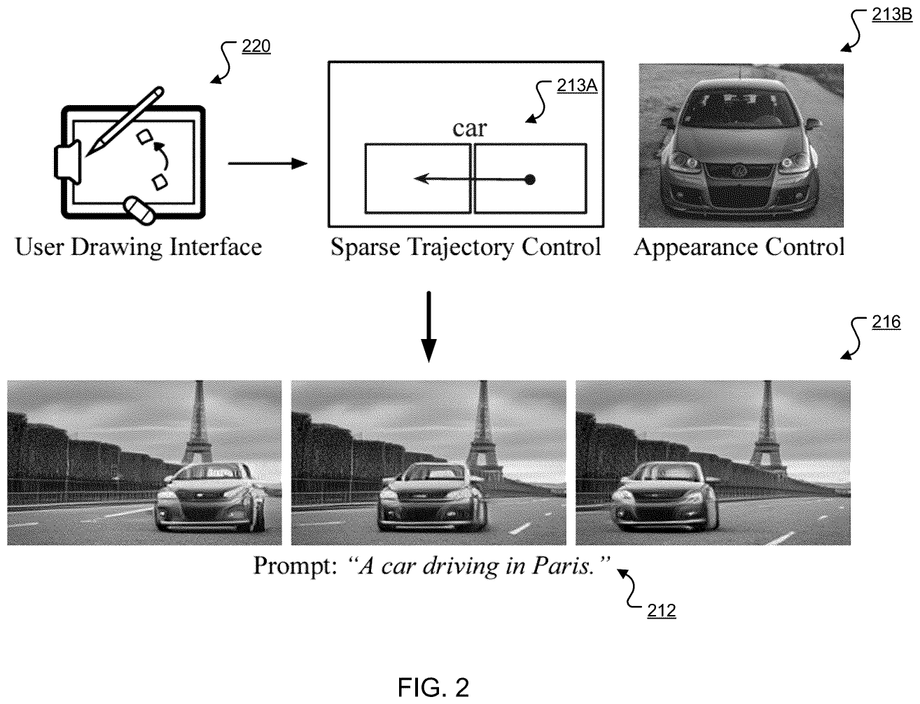

FIG. 2 is an example illustration of operations performed by the controllable video generation system 100 to generate a video.

In some implementations, the controllable video generation system 100 can provide a graphical user interface (GUI) on an electronic device that is a part of the system or in data communication with the system. For example, the electronic device can be a desktop computer, a portable computer (e.g., a notebook computer, tablet computer, or handheld device), or a personal electronic device (e.g., a wearable electronic device, such as a watch), that has a display device on which the graphical user interface (GUI) can be implemented.

In these implementations, a user can interact with the GUI through the display device, e.g., when it is a touch-sensitive display (such as a touchpad, touch screen, or a touch-screen display), or alternatively through an input device that is paired with the display device, e.g., a keyboard and a mouse, a joystick, a virtual reality, augmented reality, or mixed reality input device, or another handheld input device.

As illustrated on the top left side of FIG. 2, the controllable video generation system 100 detects one or more user inputs made by a user (e.g., through stylus, finger contacts, and/or gestures) within a graphical user interface (GUI) 220.

For example, the one or more user inputs can include a drawing input, e.g., a finger stroke on a touch-sensitive surface, that paints an object (a rectangular box) on a canvas that is presented within the GUI 220. In response to detecting the drawing input in FIG. 2, the controllable video generation system 100 generates a sketch image (e.g., a free-hand or hand-drawn sketch) of the rectangular box based on the drawing input.

As another example, the one or more user inputs can include a dragging input. For example, the user can touch an object (e.g., either an object previously painted by the user or another pre-generated object) depicted within the canvas that is presented within the GUI 220, e.g., by touching finger or a stylus to a touchscreen and then moving the finger or stylus to a different location on the touchscreen while continuing contact with the touchscreen, releasing the contact after the finger or stylus is located at the different location on the touchscreen. In response to detecting the dragging input in FIG. 2, the controllable video generation system 100 displays that the sketch image of the rectangular box moves from right to left (as indicated by the arrow).

As illustrated in the top right side of FIG. 2, the drawing input and the dragging input collectively define a trajectory 213A of the object, which is from right to left. In other examples, the one or more user inputs can include a single drawing input (or another input, e.g., a selection input) that defines the trajectory 213A of the object, e.g., a drawing input that paints an arrow on a canvas, where the direction of the arrow characterizes the trajectory.

Having obtained the trajectory of the object, the controllable video generation system 100 can translate the trajectory into the location data that defines a respective location of the object within the respective video frame at each of a plurality of time steps. The trajectory can be translated into the location data in many different ways.

In the example of FIG. 2, the controllable video generation system 100 can obtain the 2D coordinates of the corners (e.g., the top-left corner or the bottom-right corner, or other points, e.g., the geometric center) of the rectangular box in the video frame, as the rectangular box is being dragged from right to left, and then determine the location data that defines the location of the object within the respective video frame at each of the plurality of time steps based on the 2D coordinates. In particular, the locations of the object at different time steps within the plurality of time steps may, and generally will, vary.

In some other examples, the controllable video generation system can process the sketch image using an object detection neural network to generate data defining one or more bounding boxes that contain an object, and then determine the location data based on the 2D coordinates of the corners (or other points) of the bounding boxes.

In a similar example, the controllable video generation system can process the sketch image using a semantic segmentation neural network to generate data defining one or more segments in the sketch image, and then determine the location data based on the 2D coordinates of the corners (or other points) of the segments.

In yet other cases, the control input 113 includes both one or more images and location data. For example, the controllable video generation system 100 can obtain the images as a user upload while obtaining the location data based on one or more user inputs submitted by the user.

Having obtained the text prompt 112 and the control input 113, the controllable video generation system 100 generates the video 116 using multiple neural networks based on the text prompt 112 and the control input 113. The video includes a respective video frame at each of a plurality of time steps.

The multiple neural networks include a joint encoder neural network 110 and a video generation neural network 120.

The joint encoder neural network 110 is configured to process the text prompt 112 and the control input 113 to generate a plurality of embeddings that represent the text prompt 112 and the control input 113. An embedding, as used in this specification, is an ordered collection of numerical values, e.g., a vector of floating point values or other types of values.

Specifically, the joint encoder neural network 110 can process the text prompt 112 to generate a text prompt embedding 114. Further, the joint encoder neural network 110 can process the control input 113 to generate one or more control input embeddings 115. For example, when the control input includes an image, the one or more control input embeddings 115 can include an image embedding that is generated by the joint encoder neural network 110 based on the image. As another example, when the control input includes location data, the one or more control input embeddings 115 can include a location embedding that is generated by the joint encoder neural network 110 based on the location data.

The joint encoder neural network 110 can have any appropriate neural network architecture that allows the joint encoder neural network 110 to encode an input to the neural network into an embedding. For example, the joint encoder neural network 110 can include any appropriate types of neural network layers (e.g., embedding layers, fully connected layers, attention layers, and so forth) in any appropriate number (e.g., 1 layer, 2 layers, or 5 layers) and connected in any appropriate configuration (e.g., as a directed graph of layers).

The video generation neural network 120 is configured to generate the video 116 that includes the respective video frame at each of the plurality of time steps in the video while the video generation neural network 120 is conditioned on the text prompt embedding 114 and on the one or more control input embeddings 115.

The video generation neural network 120 can have any appropriate neural network architecture that allows the video generation neural network 120 to generate one or more outputs from which the video 116 can be derived.

For example, to generate the video 116 by autoregressively generating one video frame after another video frame and, for each video frame, one pixel after another pixel, the video generation neural network 120 can have an architecture similar to the architecture of the text-to-video model described in Villegas, Ruben, et al. Phenaki: Variable length video generation from open domain textual descriptions. International Conference on Learning Representations. 2022, which includes a C-ViViT encoder-decoder and a bidirectional transformer.

As another example, to generate the video 116 by predicting the entire video frame, or blocks of pixels included in the videos frame, by performing a reverse diffusion process, the video generation neural network 120 can have an architecture similar to the architecture of one of the diffusion models described in Agrim Gupta, et al. Photorealistic video generation with diffusion models. European Conference on Computer Vision. Springer, Cham, 2025, Andreas Blattmann, et al. Align your latents: High-resolution video synthesis with latent diffusion models. In CVPR, 2023, and Yuwei Guo, et al. Animatediff: Animate your personalized text-to-image diffusion models without specific tuning. arXiv preprint arXiv: 2307.04725, 2023.

Generally, however, to facilitate controllable video generation, in any of these examples or other examples, the video generation neural network 120 will include one or more cross-attention layers that each cross-attend into the text prompt embeddings 114 or the one or more control input embeddings 115 that have been generated by the joint encoder neural network 110.

In effect, the controllable video generation system 100 allows a user can define, using the control input 113, a particular object movement, a particular object appearance, or both, and the system is capable of generating a video 116 that depicts an object having the same particular movement (i.e., rather than varying movements), the particular appearance (i.e., rather than varying appearances), or both.

As illustrated on the bottom side of FIG. 2, the controllable video generation system 100 receives a text prompt 212 “A car driving in Paris.” The controllable video generation system 100 also receives a control input 213 that includes location data (that is generated based on the sketch 213A) and an image 213B of a vehicle. In response, the controllable video generation system 100 generates a video 216 conditioned on the text prompt 212 and the control input 213.

The video 216 has content that maintains close relevance to the control input 213. For example, when the control input includes an image provided by a user, the video 216 will depict an object that shares a common set of appearance characteristics with the object depicted in the image. As another example, when the control input includes a sketch that characterizes a particular trajectory provided by the user, the video 216 will depict a moving object that follows the particular trajectory characterized by the one or more user inputs.

In FIG. 2, the video 216 includes a respective video frame at each of three time steps. The video 216 captures both the appearance and motion of the object as defined by the user. That is, the video 216 includes three video frames that each show a particular instance of a vehicle having an appearance similar to particular appearance of the vehicle shown in the image 213B uploaded by the user, and that each show the vehicle located at a particular location that is along the trajectory from right to left as defined by the user that provided the drawing input—the video 216 includes a first video frame that shows the vehicle located at the right, followed by a second video frame that shows the vehicle located at the center, followed by a third video frame that shows the vehicle located at the left.

The controllable video generation system 100 can then output the generated video 116, e.g., by storing the video, providing the video for play back on a user device of the user that submitted the text prompt 112 and/or the control input 113, or outputting the video to another system for further processing.

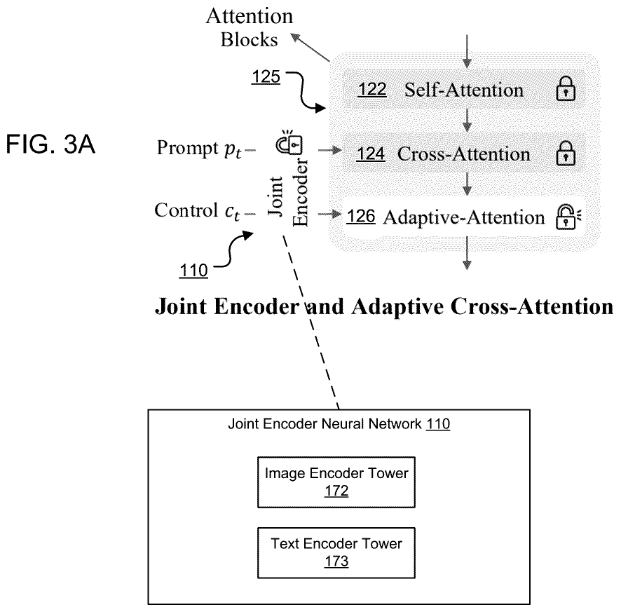

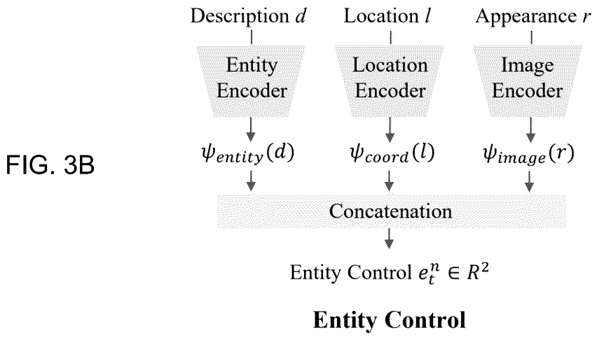

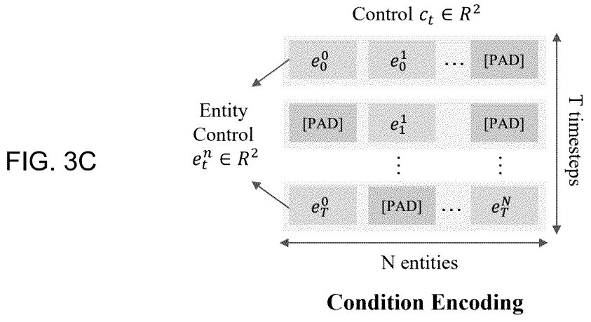

FIG. 3A illustrates example architectures of the joint encoder neural network 110 and the video generation neural network 120.

The joint encoder neural network 110 includes an image encoder tower 172 and a text encoder tower 173. The image encoder tower 172 includes a sequence of image encoder layers and is configured to process an image of an object that is included in the control input 113 using the sequence of image encoder layers to generate an image embedding.

For example, the sequence of image encoder layers can include some of the neural network layers included in a vision transformer (ViT) neural network, and, optionally, one or more multi-layer perceptron (MLP) layers.

The text encoder tower 173 includes one or more embedding layers. At each time step, the text encoder tower 173 is configured to process the portion of the location data included in the control input 113 that corresponds to the time step (the portion of the location data that defines the location of the object within the video frame at the time step) using the one or more embedding layers to generate a location embedding.

Further, at each time step, the text encoder tower 173 is configured to process the text prompt 112 using the one or more embedding layers to generate a text prompt embedding 114.

Because the locations of the object at the different time steps can vary, the location embedding generated for one of the plurality of time steps will generally differ from the location embedding generated for another one of the plurality of time steps. However, the text prompt embedding can stay the same across the plurality of time steps. The image embedding can likewise stay the same across the plurality of time steps.

The video generation neural network 120 includes a sequence of one or more attention blocks 125. Each attention block 125 includes a self-attention layer 122, followed by a cross-attention layer 124, followed by an adaptive cross-attention layer 126.

For example, when configured as having an architecture similar to the Phenaki architecture mentioned above, the video generation neural network 120 can include one or more attention blocks 125 within the bidirectional transformer. In this example, the video generation neural network 120 can generate the video by autoregressively generating one video frame after another video frame and, for each video frame, one pixel after another pixel.

As another example, when configured as having an architecture similar to the WALT architecture mentioned above, the video generation neural network 120 can include one or more attention blocks 125 within the transformer backbone. In this example, the video generation neural network 120 can generate the video by predicting the entire video frame, or blocks of pixels included in the videos frame, by performing a reverse diffusion process.

At each time step, the attention block 125 processes, by the self-attention layer 122, a self-attention layer input to generate a self-attention layer output by applying a self-attention mechanism over the self-attention layer input. Since the self-attention layer 122 is the first layer in the attention block 125, the self-attention layer input can be the same as the input to the attention block 125.

For example, when attention block is the first attention block in the sequence, the input to the attention block 125 can include an embedding for each of the one or more video frames that have already been generated for one or more preceding time steps. Optionally, the input to the attention block 125 can also include (i) the text prompt embedding and (ii) the one or more control input embeddings, e.g., the location embedding or the image embedding or both.

As another example, when the attention block 125 is not the first attention block in the sequence, the input to the attention block 125 can be the output of a preceding attention block that precedes the attention block 125 in the sequence.

Generally, to apply the self-attention mechanism, the self-attention layer 122 generates a set of queries, a set of keys, and a set of values from the self-attention layer input, and then applies any of a variety of variants of query-key-value (QKV) attention using the queries, keys, and values to generate a self-attention layer output.

At each time step, the attention block 125 process, by the cross-attention layer 124, an input to the attention block 125 or data derived from the attention block 125 to generate a cross-attention layer output.

For example, the cross-attention layer 124 can process a cross-attention layer input that includes the self-attention layer output and the text prompt embedding to generate a cross-attention layer output by applying a cross-attention mechanism over the self-attention layer output and the text prompt embedding. In cross-attention, the queries are generated from the self-attention layer output while the keys and values are generated from the text prompt embedding.

At each time step, the attention block 125 process, by the adaptive cross-attention layer 126, an input to the attention block 125 or data derived from the attention block 125 to generate an adaptive cross-attention layer output.

For example, the adaptive cross-attention layer 126 can process an adaptive cross-attention layer input that includes the cross-attention layer output and the one or more control input embeddings to generate an adaptive cross-attention layer output by applying the cross-attention mechanism over the cross-attention layer output and the one or more control input embedding. In adaptive cross-attention, the queries are generated from the cross-attention layer output while the keys and values are generated from the one or more control input embeddings.

The self-attention layer output, the cross-attention layer output, the adaptive cross-attention layer output, or some combination thereof can then be used to generate the output of the attention block 125, e.g., either as-is or by processing one or more of these layer outputs, e.g., the adaptive cross-attention layer output, using one or more additional layers.

By repeatedly performing the operations for all of the attention blocks 125 in the video generation neural network 120 and then by processing at least part of the output generated by the last attention block in the video generation neural network 120 using one or more output layers, the video generation neural network 120 can generate a video frame for the time step.

FIG. 3B illustrates example operations performed by the joint encoder neural network 110 at each time step.

The joint encoder neural network 110 processes the text prompt 112 using the text encoder tower to generate a text prompt embedding ψ_{entity}(d). The joint encoder neural network 110 processes the location data included in the control input 113 using the text encoder tower to generate a location embedding ψ_{coord}(l). The joint encoder neural network 110 processes the image included in the control input 113 using the image encoder tower to generate an image embedding ψ_{image}(r). The text prompt embedding ψ_{entity}(d), the location embedding ψ_{coord}(l), and the image embedding ψ_{image}(r) are then concatenated together, and the concatenation is provided as an input to (the first attention block 125 of) the video generation neural network 120.

For example, at the t^{th} time step in the T time steps, the concatenation eₜⁿ of the n^{th} object in the N objects specified in the text prompt can be represented as:

eₜⁿ=Concat(ψ_{entity}(dₜⁿ),ψ_{coord}(lₜⁿ),ψ_{image}(rₜⁿ).

FIG. 3C illustrates example operations performed by the controllable video generation system 100 to achieve entity control while generating a video using the video generation neural network 120.

As mentioned earlier, the video includes a respective video frame at each of a plurality of time steps, and the text prompt can specify one or more objects that should appear in the video.

In reality an object may, but need not, be depicted in each and every one of the plurality of time steps. That is, the video frame at a given time step in the plurality of time steps may depict none, or some, but fewer than all, of the one or more objects specified by the text prompt. For example, an object may be occluded (e.g., by another object) at a given time step, and thus may not be visible in the video frame at the given time step.

In some implementations, object visibility can be specified by the user as part of the control input 113. For example, for each object, the user can specify, e.g., as text prompt or another user input, the visibility duration (e.g., visible for the first 5 frames and occluded (or otherwise invisible) for the last 5 frames). Thus, the control input 113 can also include object visibility data that includes, at each of the plurality of time steps, data specifying whether each object is visible or not within the respective video frame at the time step.

To better account for the potentially missing objects during some of the plurality of video frames, in these implementations, the controllable video generation system 100 can modify the input to the video generation neural network 120 that has been generated as described above with reference to FIG. 3B, and then process the modified input using the video generation neural network 120.

In particular, assuming an object is not visible at a time step, the controllable video generation system 100 can replace the concatenation generated for the time step with a predetermined placeholder input, and then provide the predetermined placeholder input as the input to the video generation neural network 120.

As illustrated, at the 0^{th} time step in the T time steps, the n^{th} object in the N objects specified in the text prompt is missing. Accordingly, the concatenation generated for the n^{th} object at the 0^{th} time step is replaced with a predetermined placeholder input [PAD].

At the 1^{st} time step in the T time steps, the 0^{th} object and the n^{th} object in the N objects specified in the text prompt are missing. Accordingly, the concatenations generated for the 0^{th} object and the n^{th} object at the 1^{st} time step are each replaced with a predetermined placeholder input [PAD].

At the t^{th} time step in the T time steps, the 1^{st} object in the N objects specified in the text prompt is missing. Accordingly, the concatenation generated for the 1^{st} object at the t^{th} time step is replaced with a predetermined placeholder input [PAD].

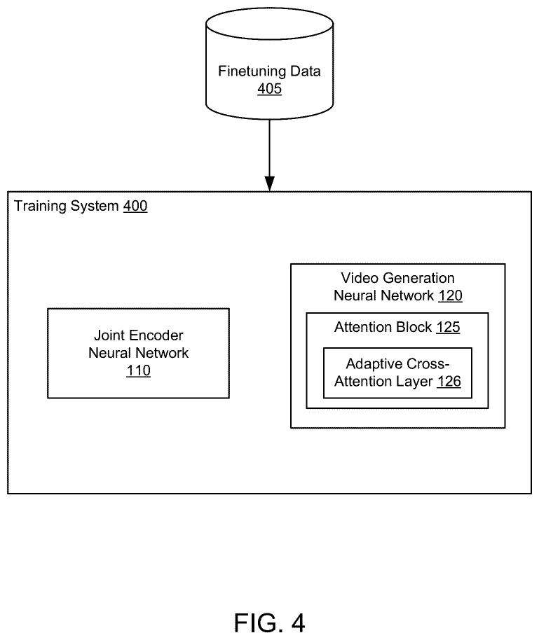

FIG. 4 shows an example training system 400. The training system 400 is an example of a system implemented as computer programs on one or more computers in one or more locations that trains the joint encoder neural network 110 and the video generation neural network 120 of FIG. 1 for the controllable video generation system 100 to use.

For example, after the training, the training system 400 can output data specifying the trained joint encoder neural network 110 and the trained video generation neural network 120, including parameter data defining the trained values of the parameters of the neural networks 110, 120 and, optionally, architecture data defining the architectures of the neural networks 110, 120 to the controllable video generation system 100—and the video generation neural network 120 deploys the trained joint encoder neural network 110 and the trained video generation neural network 120 to perform inference, i.e., to generate videos 116 based on text prompts 112 and conditioning inputs 113.

To train the joint encoder neural network 110 and the video generation neural network 120, the training system 400 obtains fine-tuning data 405, e.g., as an upload by a user of the training system or from a server, and then trains the joint encoder neural network 110 and the video generation neural network 120 to determine the trained values of at least some of the parameters of the neural networks 110, 120 based on optimizing an objective function using the fine-tuning data 405.

The fine-tuning data 405 includes a plurality of training inputs. Each training input includes (i) a training text prompt which specifies one or more objects, (ii) one or more training images that each include a depiction of a respective one of the one or more objects, and (iii) training location data that defines a respective location of each of the one or more objects specified in the training text prompt. Optionally, each training input is associated with a ground truth video frame, i.e., a target video frame that should be generated by the neural networks 110, 120 based on processing the training input.

In some implementations, the plurality of training inputs included in the fine-tuning data 405 can be generated based on video clips included in one or more video datasets. In practice, very few video datasets contain the annotations of objects' trajectories and are associated with images of objects that are present in the video clips.

Therefore, in some of these implementations, the training system 400 can utilize an object detector (e.g., an off-the-shelf object detector described in Jonathan Huang, et al. 10 Speed/accuracy trade-offs for modern convolutional object detectors. In CVPR, 2017), and an object tracker (e.g., an off-the-shelf object tracker described in Alex Bewley, et al. Simple online and realtime tracking. In ICIP, 2016) to process each video clip to extract N objects in the video clip that span T time steps and the location of each object at each of the T time steps.

Moreover, in some of these implementations, the training system 400 can obtain the one or more training images based on processing the video clips, e.g., by cropping the region of a video frame in the video clip using detected bounding boxes that each contain a depiction of one of the one or more objects.

Prior to the training, the video generation neural network 120 can be initialized based on a pre-trained video generation neural network that has been pre-trained based on optimizing a video generation pre-training objective function. Thus, the video generation neural network 120 includes some components that are the same as the pre-trained video generation neural network, and some additional components that are not in the pre-trained video generation neural network.

For example, the pre-trained video generation neural network can include one or more attention blocks 125. Each attention block 125 includes a self-attention layer followed by a cross-attention layer. As part of the initialization of the video generation neural network 120, the training system 400 adds an adaptive cross-attention layer 126 into each attention block 125. The adaptive cross-attention layer 126 can be placed at any appropriate location with each attention block 125.

For example, as illustrated in the example of FIG. 3A, the training system 400 can insert an adaptive cross-attention layer 126 after the cross-attention layer in each attention block. Thus, the video generation neural network 120 can have a similar architecture as the pre-trained video generation neural network, e.g., can include the same number of attention blocks 125, but has adaptive cross-attention layers 126 that were previously not included in those attention blocks 125 included in the pre-trained video generation neural network.

As another example, the training system 400 can insert the adaptive cross-attention layer 126 before the cross-attention layer but after the self-attention layer. As another example, the training system 400 can insert the adaptive cross-attention layer 126 before the self-attention layer.

In some implementations, the joint encoder neural network 110 can likewise be initialized based on a pre-trained encoder neural network that has been pre-trained based on optimizing an encoder pre-training objective function. For example, the image encoder tower of the joint encoder neural network 110 can be initialized based on a pre-trained vision transformer (ViT) neural network, such that the image encoder tower includes some of the neural network layers included in the pre-trained ViT neural network.

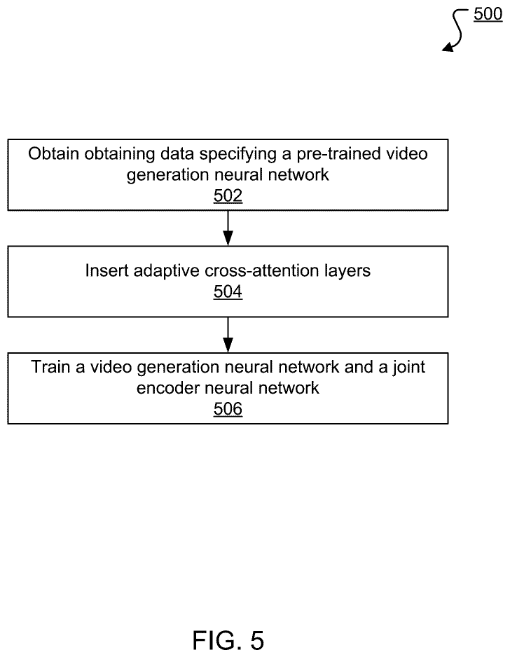

FIG. 5 is a flow diagram of an example process 500 for training a joint encoder neural network and a video generation neural network. For convenience, the process 500 will be described as being performed by a system of one or more computers located in one or more locations. For example, a training system, e.g., the training system 400 of FIG. 4, appropriately programmed in accordance with this specification, can perform the process 500.

The system obtains data specifying a pre-trained video generation neural network that has been pre-trained to generate videos conditioned on text inputs based on optimizing a video generation pre-training objective function (step 502). The pre-trained video generation neural network, e.g., a pre-trained text-to-video model, includes one or more original attention blocks. Each original attention blocks includes a self-attention layer followed by a cross-attention layer.

The pre-trained video generation neural network has parameters, including parameters of the self-attention layers and the cross-attention layers included in the original attention blocks, that have pre-trained values that are determined as a result of the pre-training.

The system generates the video generation neural network from the pre-trained video generation neural network by inserting an adaptive cross-attention layer to each of the one or more original attention blocks (step 504). The adaptive cross-attention layer can be placed at any appropriate location with each original attention block.

The system trains the video generation neural network on fine-tuning data to determine trained values of the parameters of the adaptive cross-attention layers while holding the values of the parameters of self-attention layer and the cross-attention layer included in each of the one or more original attention blocks fixed to their pre-trained values (step 506). The system trains the joint encoder neural network together with the video generation neural network on the fine-tuning data to determine trained values of at least some of the parameters of the joint encoder neural network.

The system performs the joint training of the neural networks over a plurality of training iterations. At each training iteration, the system updates the parameters of the adaptive cross-attention layers included in the video generation neural network and the parameters of at least some of the neural network layers, e.g., the embedding layers, the MLP layers, and, optionally, the ViT layers, included in the joint encoder neural network based on optimizing an objective function using a plurality of (a “batch” or “mini-batch” of) training inputs sampled from fine-tuning data.

For each one of the plurality of training inputs, the objective function can include one or more loss terms that are each defined with respect to a different aspect of a training video frame generated by using the neural networks based on processing the training input.

For example, the objective function can include a first term that evaluates a quality of the training video frame generated by the video generation neural network. For example, the first term can measure a Frechet Video Distance (FVD) between the training video frame and another video frame, e.g., the ground truth video frame (when included in the fine-tuning data) or another pre-generated video frame.

As another example, the objective function can include a second term that evaluates a text-to-image similarity between the training video frame and a training text prompt. For example, the second term can measure a CLIP text (CLIP-T) similarity between the training video frame and the training text prompt.

As another example, the objective function can include a third term that evaluates a difference between locations of an object depicted in a training video frame and locations of the object defined in the training location data. For example, the third term can measure an average precision (AP) score the locations of the object depicted in the training video frame with respect to the locations of the object defined in the training location data.

Like during inference time, the system can use an object detection neural network to process the training video frame to generate data defining one or more bounding boxes that contain an object, and then determine the locations of the object based on the 2D coordinates of the corners (or other points) of the bounding boxes.

As another example, the objective function can include a fourth term that evaluates an image-to-image similarity between a training video frame and the training image. For example, the fourth term can measure a CLIP video (CLIP-V) similarity between the training video frame and the training image. CLIP-T and CLIP-V similarities are described in Alec Radford, et al. Learning transferable visual models from natural language supervision. International conference on machine learning. PMLR, 2021.

As another example, the objective function can include two of more of: the first term, the second term, the third term, or the fourth term. That is, the objective function can compute a loss that is a combination, e.g., a weighted or unweight sum, of two of more of the multiple terms mentioned above. Optionally, the objective function can also include other terms, e.g., regularization terms, auxiliary loss terms, and so on, that do not depend on the ground truth video frames.

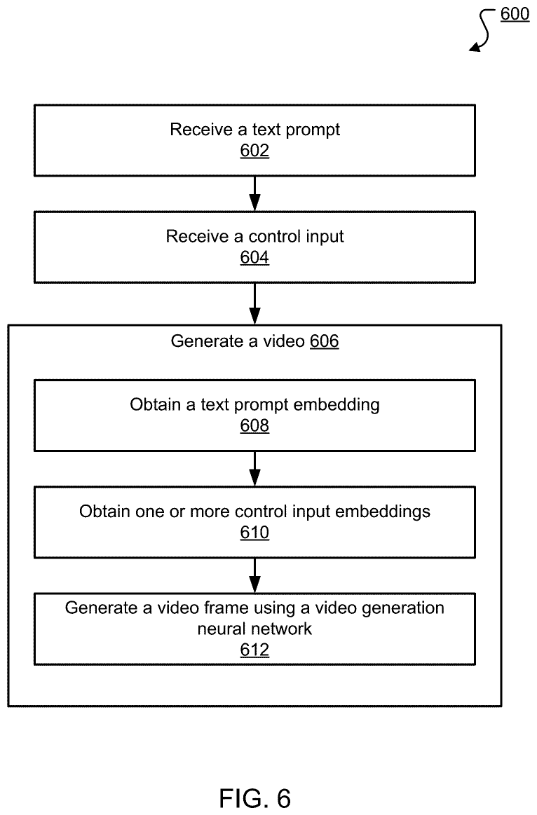

FIG. 6 is a flow diagram of an example process 600 for generating a video. The video includes a respective video frame at each of a plurality of time steps. For convenience, the process 600 will be described as being performed by a system of one or more computers located in one or more locations. For example, a controllable video generation system, e.g., the controllable video generation system 100 of FIG. 1, appropriately programmed in accordance with this specification, can perform the process 600.

The system receives a text prompt that specifies one or more objects (step 602). For example, a user can submit the text prompt in any of a variety of ways, e.g., by entering text using an input device or by submitting an audio input that is transcribed by the system.

The system receives a control input (step 604). In some cases, the control input includes, for each of the one or more objects, an image that depicts a particular instance of the object. For example, the system can obtain the images, e.g., as an upload by a user of the system or from a storage device of the system or another system.

In some other cases, the control input includes location data that defines, for each of the one or more objects, a location of the object within the respective video frame at each of the plurality of time steps. For example, a user can submit one or more user inputs that characterize a trajectory of the object across the plurality of time steps, and the system can then determine, from the one or more user inputs, the location of the object within the respective video frame at each of the plurality of time steps.

The one or more user inputs can be submitted by the user by using one or more input devices in data communication with the system, e.g., a keyboard and a mouse, a joystick, a touch screen, a virtual reality, augmented reality, or mixed reality input device, or another handheld input device. For example, the one or more user inputs can include a drawing input that specifies a sketch image, a dragging input that drags the sketch image, and so on.

In yet other cases, the control input includes both the one or more images and the location data.

The system generates a video (step 606). The video includes the respective video frame at each of the plurality of time steps in the video. The video has content that maintains close relevance to the control input.

For example, at least some of the plurality of video frames can depict the particular instance of each of the one or more objects that is depicted in the one or more images. Moreover, for each of the plurality of time steps, the video frame at the time step can depict the particular instance of each of the one or more objects at the location within the video frame that is defined in the control input.

To generate such a video, the system repeatedly performs following steps 608-612 at each of the plurality of time steps.

The system obtains a text prompt embedding at the time step (step 608). The text prompt embedding is generated based on processing the text prompt using the joint encoder neural network. In some implementations, the text prompt embedding can stay the same across the plurality of time steps.

The system obtains one or more control input embeddings at the time step (step 610). For example, when the control input includes an image, the one or more control input embeddings can include an image embedding that is generated based on processing the image using the joint encoder neural network. As another example, when the control input includes location data, the one or more control input embeddings can include a location embedding that is generated based on processing the location data using the joint encoder neural network.

In some implementations, the image embedding for each object can stay the same across the plurality of time steps. However, because the locations of each object at the different time steps can vary, the location embeddings for the plurality of time steps will generally differ from each other.

The system generates the respective video frame at the time step using a video generation neural network while the video generation neural network is conditioned on the text prompt embedding and on the one or more control input embeddings (step 612). When the time step is not the first time step in the plurality of time steps, the video generation neural network can optionally also be conditioned on the video frames that have already been generated for one or more preceding time steps.

For example, the video generation neural network can generate the video by autoregressively generating one video frame after another video frame and, for each video frame, one pixel after another pixel. As another example, the video generation neural network can generate the video by predicting the entire video frame, or blocks of pixels included in the videos frame, by performing a reverse diffusion process. In either example, the video generation neural network includes one or more attention blocks. Each attention block includes an adaptive cross-attention layer that cross-attends into the one or more control input embeddings.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method comprising:
receiving a text prompt that specifies an object;
receiving a control input that comprises an image that depicts a particular instance of the object;
generating a video that comprises a respective video frame at each of a plurality of time steps in the video and that depicts the particular instance of the object, wherein generating the video comprises, at each of the plurality of time steps:
obtaining a text prompt embedding that is generated by a joint encoder neural network based on the text prompt;
obtaining a control input embedding, the control input embedding comprising an image embedding that is generated by the joint encoder neural network based on the image; and
generating the respective video frame at the time step using a video generation neural network while the video generation neural network is conditioned on the text prompt embedding and on the control input embedding.

2. The method of claim 1, wherein obtaining the control input embedding comprises:
processing the image using an image encoder tower of the joint encoder neural network to generate the image embedding.

3. The method of claim 1, wherein the control input further comprises location data that defines a location of the object within the respective video frame at each of the plurality of time steps, and wherein the video depicts the particular instance of the object at the defined location within the respective video frame at each of the plurality of time steps.

4. The method of claim 3, wherein receiving the control input comprises:
receiving one or more user inputs that characterize a trajectory of the object across the plurality of time steps; and
determining, from the user input, the location of the object within the respective video frame at each of the plurality of time steps.

5. The method of claim 4, wherein the one or more user inputs comprise a drawing input that specifies a sketch image.

6. The method of claim 3, wherein the control input embedding further comprises a location embedding that is generated by the joint encoder neural network based on the location data.

7. The method of claim 6, wherein obtaining the control input embedding comprises:
processing the location data using a text encoder tower of the joint encoder neural network to generate the location embedding.

8. The method of claim 1, wherein the video generation neural network comprises one or more attention blocks, wherein each attention block comprises a self-attention layer followed by a cross-attention layer followed by an adaptive cross-attention layer, and wherein generating the respective video frame at the time step using the video generation neural network while the video generation neural network is conditioned on the text prompt embedding and on the control input embedding comprises:
processing, by the self-attention layer, a self-attention layer input that comprises the text prompt embedding and the control input embedding to generate a self-attention layer output by applying a self-attention mechanism over the self-attention layer input;
processing, by the cross-attention layer, the self-attention layer output and the text prompt embedding to generate a cross-attention layer output by applying a cross-attention mechanism over the self-attention layer output and the text prompt embedding; and
processing, by the adaptive cross-attention layer, the cross-attention layer output and the control input embedding to generate an adaptive cross-attention layer output by applying the cross-attention mechanism over the cross-attention layer output and the control input embedding.

9. A computer-implemented method of training a video generation neural network, wherein the method comprises:
obtaining data specifying a pre-trained video generation neural network that has been pre-trained to generate videos conditioned on text inputs, wherein the pre-trained video generation neural network comprises one or more original attention blocks, each original attention blocks comprising a self-attention layer followed by a cross-attention layer;
generating the video generation neural network from the pre-trained video generation neural network by inserting an adaptive cross-attention layer to each of the one or more original attention blocks; and
training the video generation neural network to determine trained parameter values of the adaptive cross-attention layers while holding pre-trained parameter values of the self-attention layer and the cross-attention layer included in each of the one or more original attention blocks fixed.

10. The method of claim 9, wherein training the video generation neural network comprises training the video generation neural network on a plurality of training inputs to optimize an objective function, wherein each training input includes (i) a training text prompt, (ii) a training image, and (iii) training location data.

11. The method of claim 10, wherein training the video generation neural network comprises generating the training location data for each of the plurality of training inputs by applying an object detector and an object tracker to a plurality of video clips.

12. The method of claim 10, wherein the objective function evaluates, for each of the plurality of training inputs:
(i) a quality of training video frames generated by the video generation neural network,
(ii) a text-to-image similarity between each of the training video frames and training text,
(iii) a difference between locations of an object depicted in the training video frames and locations of the object defined in the training location data, and
(iv) an image-to-image similarity between each of the training video frames and the training image.

13. The method of claim 12, wherein the quality of training video frames is evaluated using a Frechet Video Distance (FVD) metric.

14. A system comprising one or more computers and one or more storage devices storing instructions that are operable, when executed by the one or more computers, to cause the one or more computers to perform operations comprising:
receiving a text prompt that specifies an object;
receiving a control input that comprises an image that depicts a particular instance of the object;
generating a video that comprises a respective video frame at each of a plurality of time steps in the video and that depicts the particular instance of the object, wherein generating the video comprises, at each of the plurality of time steps:
obtaining a text prompt embedding that is generated by a joint encoder neural network based on the text prompt;
obtaining a control input embedding, the control input embedding comprising an image embedding that is generated by the joint encoder neural network based on the image; and
generating the respective video frame at the time step using a video generation neural network while the video generation neural network is conditioned on the text prompt embedding and on the control input embedding.

15. The system of claim 14, wherein obtaining the control input embedding comprises:
processing the image using an image encoder tower of the joint encoder neural network to generate the image embedding.

16. The system of claim 14, wherein the control input further comprises location data that defines a location of the object within the respective video frame at each of the plurality of time steps, and wherein the video depicts the particular instance of the object at the defined location within the respective video frame at each of the plurality of time steps.

17. The system of claim 16, wherein receiving the control input comprises:
receiving one or more user inputs that characterize a trajectory of the object across the plurality of time steps; and
determining, from the user input, the location of the object within the respective video frame at each of the plurality of time steps.

18. The system of claim 17, wherein the one or more user inputs comprise a drawing input that specifies a sketch image.

19. The system of claim 16, wherein the control input embedding further comprises a location embedding that is generated by the joint encoder neural network based on the location data.

20. A non-transitory computer storage medium encoded with instructions that, when executed by one or more computers, cause the one or more computers to perform operations comprising:
receiving a text prompt that specifies an object;
receiving a control input that comprises an image that depicts a particular instance of the object;
generating a video that comprises a respective video frame at each of a plurality of time steps in the video and that depicts the particular instance of the object, wherein generating the video comprises, at each of the plurality of time steps:
obtaining a text prompt embedding that is generated by a joint encoder neural network based on the text prompt;
obtaining a control input embedding, the control input embedding comprising an image embedding that is generated by the joint encoder neural network based on the image; and
generating the respective video frame at the time step using a video generation neural network while the video generation neural network is conditioned on the text prompt embedding and on the control input embedding.
